(19) United States
(12) Patent Application Publication
(10) Pub. No.: US 2025/0078018 A1
(43) Pub. Date: Mar. 6, 2025

(54) PREVENTING EMISSION DEVIATIONS OF SHIPMENTS

(71) Applicant: Federal Express Corporation, Memphis, TN (US)

(72) Inventors: Jessica BRADFORD, Memphis, TN (US); Jayandan B. PAZHAYIDATHU, Plano, TX (US); Gaurav C. PHADKE, Plano, TX (US)

(73) Assignee: Federal Express Corporation, Memphis, TN (US)

(21) Appl. No.: 18/820,835

(22) Filed: Aug. 30, 2024

Related U.S. Application Data
(60) Provisional application No. 63/580,133, filed on Sep. 1, 2023.

(51) Int. Cl. G06Q 10/0833; G06Q 10/047

(52) U.S. Cl. CPC G06Q 10/0833; G06Q 10/047

(57) ABSTRACT

Systems, methods, and non-transitory computer-readable media including instructions for preventing emission deviations of shipments are disclosed. In one embodiment, a method may include storing, in a plurality of non-transitory storage devices, shipments records having information in a normalized format about shipment emissions. The method also includes providing real-time updates to users, via a graphical interface, about a shipment associated with multiple segments with different vehicles that generate raw emission data. The method further include converting the raw emission data received from the shipment vehicles into updated information in a normalized format. This information is stored in the shipment records and used to determine if a predicted emission level deviates from a target emission level. Thereafter, a message may be automatically generated and transmitted to all users in real time, enabling the users to view the updated information reflective of the emissions released during the completed segments of the shipment route.

### CROSS-REFERENCE TO RELATED APPLICATIONS

This application is based on and claims benefit of priority of U.S. Provisional Patent Application No. 63/580,133, filed Sep. 1, 2023, the disclosure of which is incorporated herein by reference.

### TECHNICAL FIELD

The present disclosure generally relates to systems and methods for monitoring shipments. More particularly, the present disclosure relates to systems and methods for managing emissions of shipments.

### BACKGROUND

As the awareness of environmental issues and the detrimental effects of greenhouse gases and carbon emissions become more prevalent, both individuals and organizations are acknowledging the necessity to minimize their carbon footprints. This recognition has led to an increased demand for technical solutions that can effectively monitor and manage the environmental impact of their shipments.

Various initiatives have been undertaken to monitor and reduce greenhouse gases and carbon emissions, including the adoption of zero-emission electric vehicles and other sustainable solutions. However, monitoring emissions from shipments is challenging due to the complexity of using different types of delivery vehicles to complete a single shipment.

To ensure the effectiveness of these emission-reduction efforts, there is a need for a system that can calculate, monitor, and track shipment emissions at each segment of the delivery route. For instance, a disclosed sustainability system could calculate and forecast emission data, providing both organizations and individuals with historical and predictive information about the environmental impacts of their shipments in a normalized format. This sustainability system could also prevent emission deviations from a target level by enabling users to make real-time decisions, such as adjustments to the delivery route, when a predicted emission deviation of a shipment is detected.

### SUMMARY

Embodiments consistent with the present disclosure provide systems, methods, and non-transitory computer-readable storage media for monitoring emission of shipments.

Some disclosed embodiments may include systems, methods and non-transitory computer readable media for preventing emission deviations of shipments. These embodiments may involve storing information in a normalized format about shipment emissions in a plurality of network-based non-transitory storage devices having a collection of shipments records stored thereon; providing remote access over a computer network to a set of users associated with a shipment of an item, such that any one of the set of users can receive through a graphical user interface a real time update about of a deviation from a target emission level of the shipment of the item, wherein a shipment route of the item has multiple segments with differing shipment vehicles that generate emission data in a raw format that does not account for properties of the item relative to properties of other items being transported in the shipment vehicles; converting, by a shipment management server, the raw emission data received from the shipment vehicles into updated information reflective of emissions released during completed segments of the shipment route in a normalized format; storing the updated information in the collection of the shipments records in the normalized format; automatically generating a message when a predicted level of emission of the shipment of the item deviates from the target emission level; and transmitting the message to all of the set of users over the computer network in real time, such that any one of the set of users can view the updated information reflective of the emissions released during the completed segments of the shipment route in a normalized format.

The foregoing general description and the following detailed description are exemplary and explanatory only and are not restrictive of the claims.

### BRIEF DESCRIPTION OF THE DRAWINGS

FIG. 1 is a block diagram illustrating an emissions control system, consistent with some embodiments of the present disclosure.

FIG. 2 is a schematic diagram of an exemplary server of the emissions control system, according to some embodiments of the present disclosure.

FIGS. 3A-3C are examples of a GUI for interaction with the emissions control system, consistent with some embodiments of the present disclosure.

FIG. 4 is a flowchart illustrating an exemplary method for preventing emission deviations of shipments, consistent with some disclosed embodiments.

FIG. 5 is a flowchart illustrating an exemplary method for diverting shipment to an alternative route based on emissions levels, consistent with some disclosed embodiments.

### DETAILED DESCRIPTION

It will be appreciated that the embodiments of the present disclosure are not limited to the exact construction described below and illustrated in the accompanying drawings, and that various modifications and changes may be made without departing from the scope thereof. And other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Various terms used in the specification and claims may be defined or summarized differently when discussed in connection with different disclosed embodiments. It is to be understood that the definitions, summaries and explanations of terminology in each instance apply to all instances, even when not repeated, unless the transitive definition, explanation, or summary would result in inoperability of an embodiment. It is also to be understood that once a term is defined herein, in the absence of an inherent inconsistency, that definition applies to all other uses of the term herein. Moreover, the exemplary embodiments of the figures and their description are not to be considered definitions of claim terms, but rather are non-limiting examples used to illustrate specific embodiments.

Throughout, this disclosure mentions “embodiments” and “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. This disclosure employs open-ended permissive language, indicating for example, that some embodiments “may” employ, involve, or include specific features. The use of the term “may,” and other open-ended terminology, is intended to indicate that although not every embodiment may employ the specific disclosed feature, at least one embodiment employs the specific disclosed feature.

Embodiments described herein may refer to a non-transitory computer-readable medium containing instructions that, when executed by at least one processor, cause the at least one processor to perform operations for executing a method. Non-transitory computer-readable media may include any medium capable of storing data in any memory in a way that may be read by any computing device with a processor to carry out methods or any other instructions stored in the memory. The non-transitory computer-readable medium may be implemented as hardware, firmware, software, or any combination thereof. Moreover, the software may preferably be implemented as an application program tangibly embodied on a program storage unit or computer-readable medium consisting of parts, or of certain devices or a combination of devices. The application program may be uploaded to, and executed by, a machine having any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program or any combination thereof which may be executed by a CPU, whether or not such a computer or processor is explicitly described. In addition, various other peripheral units may be connected to the computer platform, such as an additional data storage unit and a printing unit. Furthermore, a non-transitory computer-readable medium may be any computer-readable medium except for a transitory propagating signal.

Some disclosed embodiments may involve “at least one processor,” which may include any physical device or group of devices having electric circuitry that performs a logic operation on an input or on inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The term memory as used in this context and other contexts may include a Random Access Memory (RAM), a Read-Only Memory (ROM), a hard disk, an optical disk, a magnetic medium, a flash memory, other permanent, fixed, or volatile memory, or any other mechanism capable of storing instructions. Memory may include one or more separate storage devices collocated or disbursed, capable of storing data structures, instructions, or any other data. Memory may further include a memory portion containing instructions for the processor to execute. The memory may also be used as a working scratch pad for the processors or as a temporary storage

In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively and may be co-located or located remotely from each other. The processors may be coupled electrically, magnetically, optically, acoustically, mechanically or by other means that permit them to interact.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, a data structure may be owned or operated by the same or different entities. Thus, the term “data structure” as used herein in the singular is inclusive of plural data structures.

Some embodiments disclosed herein may involve a network. A network may include any type of physical or wireless computer networking arrangement used to exchange data. For example, a network may be the Internet, a private data network, a virtual private network using a public network, a Wi-Fi network, a LAN or WAN network, a combination of one or more of the forgoing, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

In the following specification, embodiments are described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as examples only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

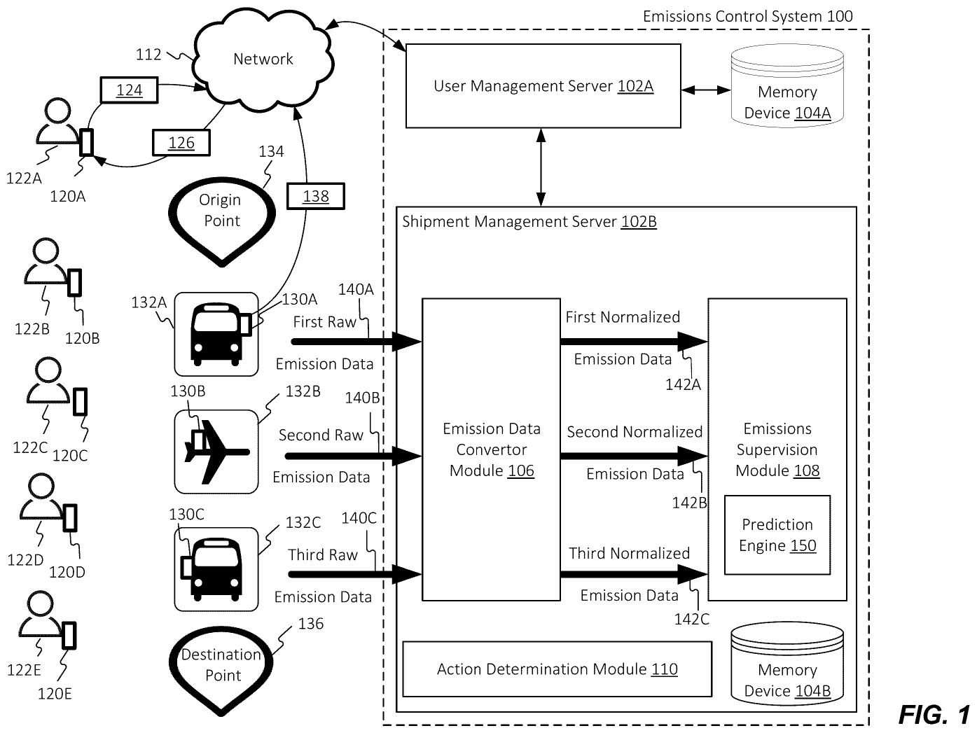

FIG. 1 is a block diagram showing various exemplary components of a sustainability system for managing the emissions of shipment, consistent with some embodiments of the present disclosure.

In some embodiments, emissions control system 100 may be configured to monitor real-time emissions of shipments and to prevent emission deviations in shipments. In the context of this disclosure, a shipment may include, for example, one or more packages, envelopes, pallets, shipment containers, trailers, or other types of shipments. Emissions control system 100 may include at least one server 102, and at least one memory device 104. In the implementation illustrated in FIG. 1, emissions control system 100 user management server 102A and shipment management server 102B. User management server 102A is associated with a memory device 104A and shipment management server 102B is associated with an emission data convertor module 106, an emissions supervision module 108, an action determination module 110, and a memory device 104B. To monitor real-time emissions of shipments, emissions control system 100 may communicate over at least one network 112 with user devices 120 (e.g., different user devices are labeled 120A-120E in FIG. 1) associated with users 122 (e.g., different devices s are labeled 122A-122E in FIG. 1), and communicate over at least one network 112 with sensor devices 130 (e.g., different sensor devices are labeled 130A-130C in FIG. 1) associated with different shipment vehicles 132 (e.g., different shipment vehicles are labeled 132A-132C in FIG. 1) along a shipment route from origin point 134 to destination point 136.

In some embodiments, the operation of an emissions control system may be centralized, using a single server, or it may be distributed across multiple servers. These servers may be owned or operated by the same or different entities, providing flexibility in system operation and management. As shown, emissions control system 100 may include user management server 102A responsible for managing communications from and to users 122. For example, user management server 102A may handle user queries, process user data, or facilitate user interactions with the system. Emissions control system 100 may also include a shipment management server 102B responsible for managing communications from and to shipment vehicles 132. For example, shipment management server 102B may monitor shipment locations, track delivery progress, monitor emission levels during shipments, and/or manage data related to shipment conditions. User management server 102A and shipment management server 102B may work together to ensure efficient operation of emissions control system 100.

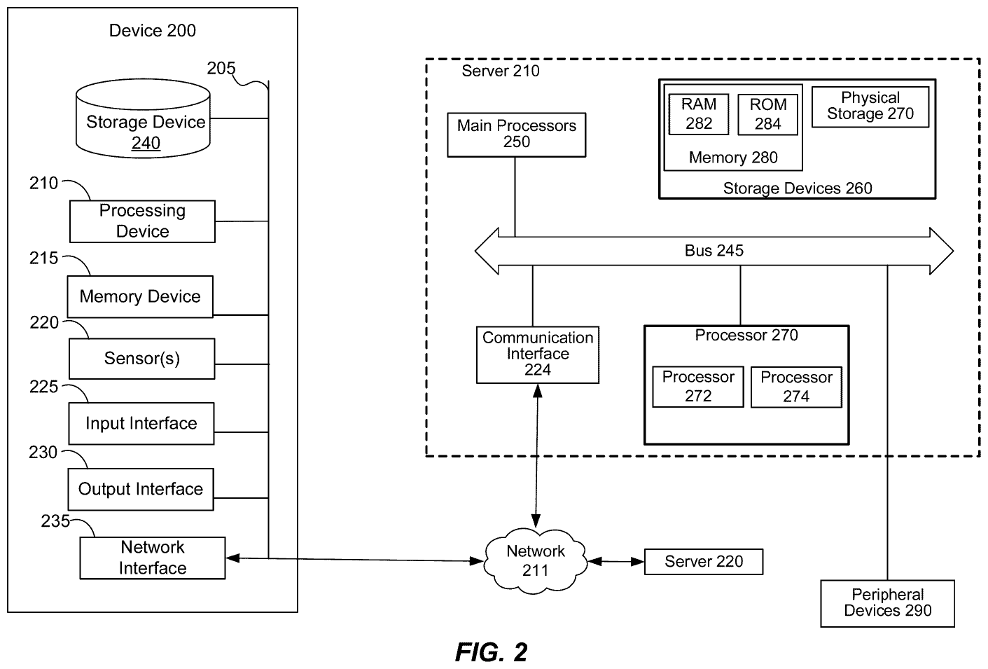

In some cases, user management server 102A and/or shipment management server 102B may be cloud servers. The term “cloud server” refers to a computer platform that provides services via a network, such as the Internet. The servers of emissions control system 100 may use one or more virtual machines that may not correspond to individual pieces of hardware. For example, computational and/or storage capabilities may be implemented by allocating appropriate portions of desirable computation/storage power from a scalable repository, such as a data center or a distributed computing environment. Additional details on an example server of emissions control system 100 are provided below with reference to FIG. 2.

Emissions control system 100 may acquire information from multiple sources. In some embodiments, information about shipment emissions may be stored in a normalized format in plurality of network-based non-transitory storage devices, for example, memory device 104A and memory device 104B. The memory devices may have a collection of shipments records stored thereon. In additional embodiments, the information stored in memory device 104A and memory device 104B may include shipment data. The shipment data may be, for example, the mode of transportation (e.g., vehicle, boat, plane, etc.), an estimated amount of volume associated with the shipment, the weight of the shipment, the service level associated with the package, the type of fuel used based on the mode of transportation, the number of legs along a particular route, mileage for the origin and destination points, and any other data relevant to the shipment of an item. In addition, the information stored in memory device 104A and/or memory device 104B may include historical data. The historical data may be, for example, an amount of time expected to transport a shipment from an origin point to a destination point, an amount of fuel used by the carrier during transportation of a shipment, a type of fuel used by the transportation vessel (e.g. gasoline, diesel, jet fuel, natural gas etc.), the type of transportation used for a shipment, an amount of time expected to stop along the transportation route, a number of stops along a transportation route, a type of service (express versus ground), alert condition information (e.g. related to unexpected weather events), data related to route delays (e.g. due to weather, traffic, accidents, construction etc.), re-routing information, time of year, weather conditions, an amount of emissions per stop associated with delivering packages based at least in part on the type of transportation, and more. In some cases, the re-routing information may include information associated with one or more changes in the shipment route, including changes in an origin or destination point or in the number and/or location of stops along a route, a type of carrier, a mode of transportation, or a class of service associated with a particular shipment.

As shown in FIG. 1, shipment management server 102B may include emission data convertor module 106 that may be configured to receive raw emission data 140 from shipment vehicles 132 and to convert them into normalized emission data 142. The normalized emission data 142 is reflective of emissions released during completed segments of the shipment route in a normalized format. In some cases, the process of converting the raw emission data into updated emission information in a normalized format involves determining the emission contribution of the shipped item relative to other items being transported via shipment vehicles. To do, shipment management server 102B may obtain shipment information. This shipment information may reflect the available load capacity of the shipment vehicles and/or the properties (e.g., weight and size) of all items being transported via the differing shipment vehicles. In some embodiments, data convertor module 106 may convert raw emission data 140 of each segment of the shipment route separately. For example, emission data convertor module 106 may convert first raw emission data 140A into first normalized emission data 142A based on shipment information associated with first shipment vehicle 130A, convert second raw emission data 140AB into second normalized emission data 142B based on shipment information associated with second shipment vehicle 130B, and convert third raw emission data 140AC into third normalized emission data 142C based on shipment information associated with third shipment vehicle 130C.

Shipment management server 102B may also include an emissions supervision module 108. This module may be used to predict when the emission level of a particular shipment might deviate from a predetermined target emission level. Consistent with the present disclosure, emissions supervision module 108 may determine a target emission level for any shipment of an item. In one possible embodiment, the target emission level may be determined based on input (e.g., input 124) received from one of users 122 associated with the item's shipment. For instance, a shipper might specify a target emission level in line with their company's sustainability goals. In another possible embodiment, the target emission level could be determined based on an emission policy related to the item. For example, if the item being shipped is a hazardous material, the target emission level might be set higher to minimize environmental risks. In yet another embodiment, the target emission level may be determined based on an emission policy associated with one of the users. For instance, a user might have a company-wide policy to reduce carbon emissions, which may influence the target emission level.

In some embodiments, emissions supervision module 108 may also predict the final emission level of the item's shipment based on ongoing normalized emission data 142B. This data may be associated with completed segments of the shipment route and estimated emission level may relate to future segments of the shipment. In some cases, the estimated emission information for future segments of the shipment could be based on environmental conditions, such as weather patterns or traffic congestion. In other cases, the estimated emission information for future segments of the shipment may be based on historical data indicative of past emissions, such as records of previous shipments' emission levels. For example, emissions supervision module 108 may use data from previous shipments along the same route to predict the future emissions on the ongoing delivery. The prediction of the emission level of the item's shipment may be accomplished by a prediction engine 150 which may be part of emissions supervision module 108 and is described below in greater detail.

Shipment management server 102B may also include an action determination module 110. This module may be used to ascertain whether an action needs to be initiated based on output of emissions supervision module 108. For instance, action determination module 110 may initiate an action if the projected emission level of a shipment deviates from a pre-determined target emission level. Action determination module 110 may also decide which specific action is to be taken and the appropriate timing for it. Examples actions that action determination module 110 may consider when the projected emission level of a shipment deviates from the target emission level may include, notifying an associated user on the deviations, adjusting the shipping route, changing the delivery time, modifying the shipment method, replacing the delivery vehicles, and/or any other actions that may help to reduce the emission level.

In some embodiments, action determination module 110 may also determine an alternative shipment route based on the current emission data and the target emission level. Specifically, action determination module 110 may automatically initiate a change to the shipment route if the predicted emission level of the item's shipment deviates from the target level. For example, if a scheduled route is predicted to result in higher emissions than what was originally predicted, emissions supervision module 108 may reroute the shipment to a more environmentally friendly path. Alternately or additionally, action determination module 110 may decide which shipment vehicles to use for the item's shipment based on the target emission level. In some cases, action determination module 110 may automatically initiate a change to the scheduled shipment vehicles if the predicted emission level of the item's shipment deviates from the target level. For example, if using a certain truck according to the original delivery route is predicted to exceed the target emission level, emissions supervision module 108 may switch to a more efficient vehicle.

In other embodiments, action determination module 110 may generate a real-time message (e.g., message 126) for transmission to one or more users 122 via network 112. The message may be a text message (e.g., SMS) with a link to a website or a notification in a GUI associated with emissions control system 100 (e.g., GUI 300). This message may allow each user to view information that reflects the emissions released during the completed segments of the shipment route in a normalized format, such as normalized emission data 142B. In some cases, message 126 may propose an alternative shipping route that would rectify the deviation from the target emission level of the shipment. For example, if a shipment is projected to exceed the target emission level due to its current route, message 126 may suggest a more environmentally friendly route that reduces the overall emissions. In other embodiments, message 126 may contain a report with updated information about the with shipment (e.g., emission data in a normalized format). This report may be customizable and include the current location of the shipment, the estimated time of arrival, the cumulative emissions released thus far, and any other data relevant for the shipment.

Emissions control system 100 may communicate over a computer network 112 with users 122 and with shipment vehicles 132. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. Moreover, one or more aspects of the disclosed systems and methods may also be used in a localized system, with one or more of the components of emissions control system 100 communicating directly with each other using computer network 112. While FIG. 1 illustrates that only user device 120A communicates with emissions control system 100, it is understood that emissions control system 100 may communicate with all (or part of) user devices 120, with all (or part of) sensor devices 130, and/or with all (or part of) shipment vehicles 132.

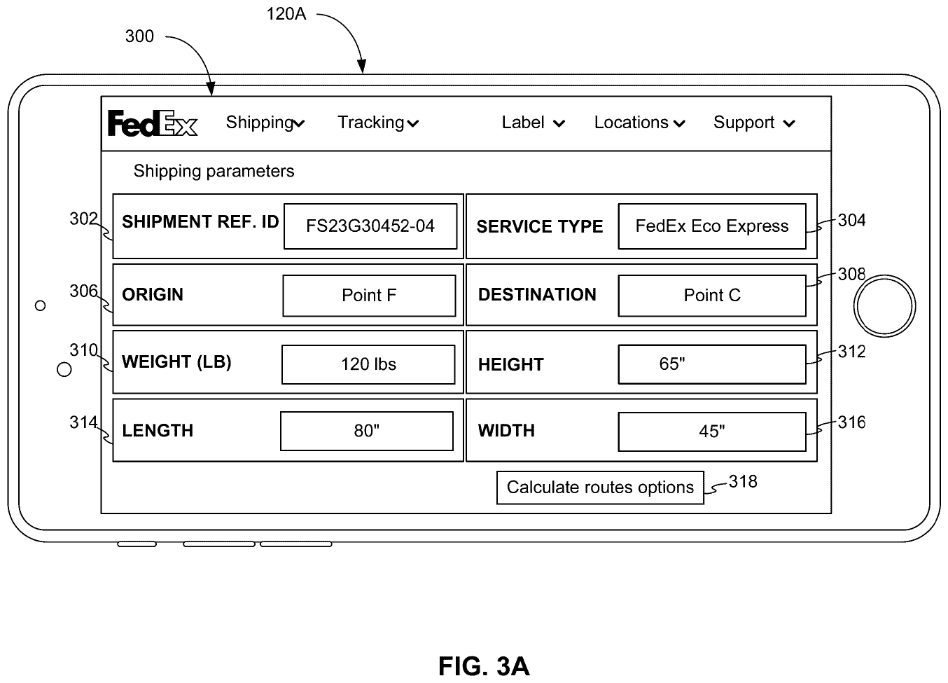

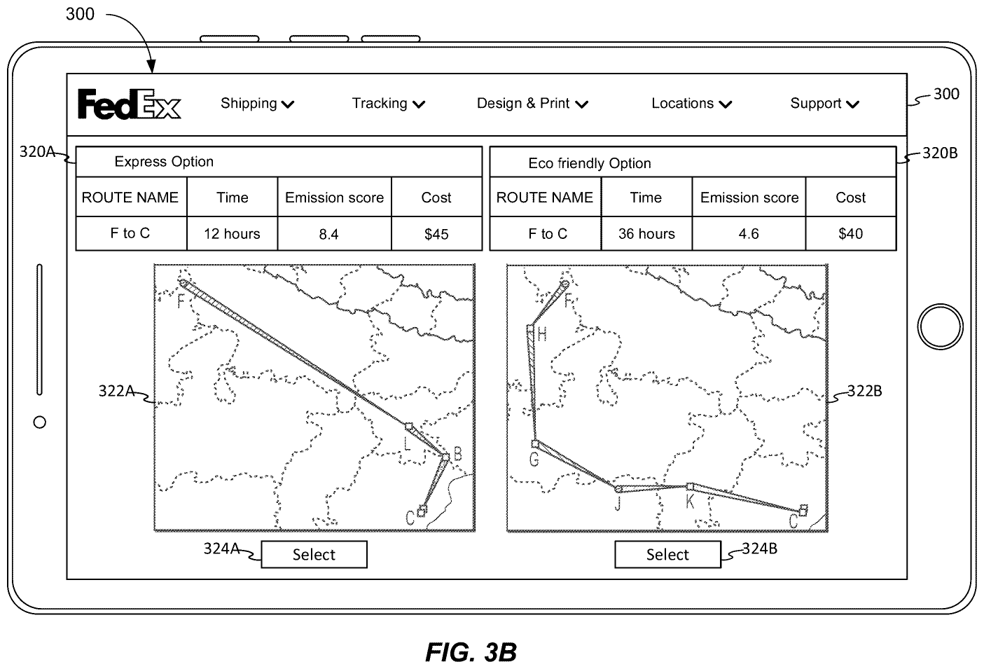

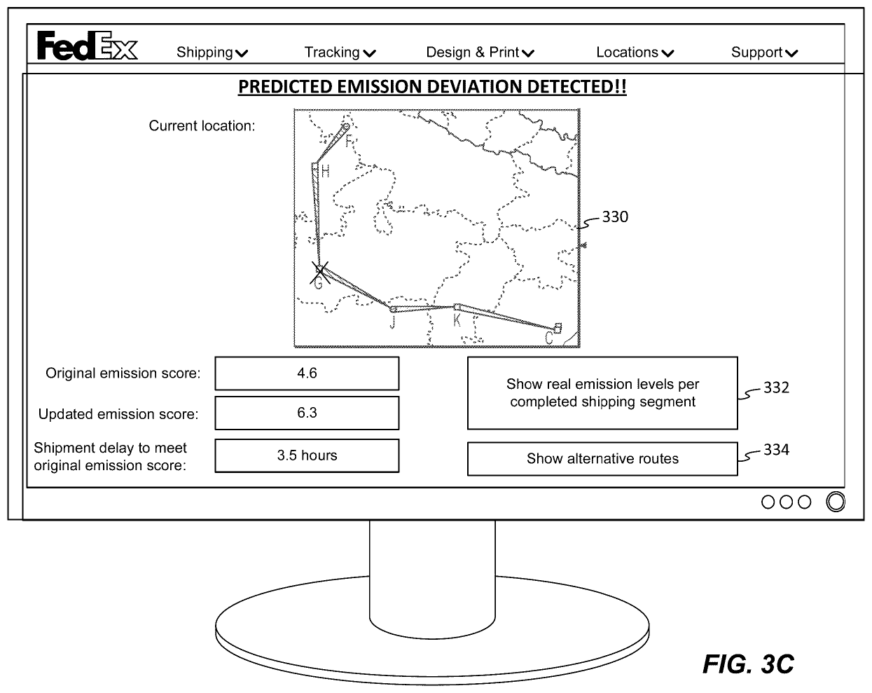

User devices 120 may include any form of computer-based device or entity through which users 122 may interact with emissions control system 100. For example, user device 120 may be a personal computer (e.g., a desktop or laptop computer), a mobile device (e.g., a mobile phone or tablet), or any other device that may be capable of accessing web pages or other network locations. In some embodiments, user device 120 may be a virtual machine (e.g., based on AWS™, Azure™, IBM Cloud™, etc.), container instance (e.g., Docker™ container, Java™ container, Windows Server™ container, etc.), or other virtualized instance. In some embodiments, user device 120 may be configured to generate a request for an emission status of a shipment. In some embodiments, user device 120 may be configured to generate a request for a prediction in response to user interaction with user device 120. The user interaction may include a user input to user device 120. In some embodiments, user device 120 may be provided with a user interface associated with emissions control system 100 (e.g., user interface 300 in FIG. 3).

Consistent with the present disclosure, one or more users 122 may be any entity (e.g. an individual or an organization) associated with at least one of: a shipper, a recipient, a carrier, a logistics provider, or any other parties that wish to know emission data associated with shipments of items before, during, and after transport to satisfy quality control goals, meet regulatory requirements, and optimize business processes. In some embodiments, shipment management server 102B may also include a module for authenticating users to confirm that each user has permission to receive emission data associated with the shipment of the item, such that message 126 is transmitted to only authenticated users. In addition, some users may have permission to only view emission data, while other users may have permission to take actions, such as changing the delivery route.

Sensor device 130 may include a combination of detectors for monitoring a wide array of pollutants by integrating multiple sensing technologies to provide real-time data on one or more of: carbon dioxide (CO₂), carbon monoxide (CO), nitrogen oxides (NOₓ), hydrocarbons (HC), particulate matter (PM), methane (CH₄), sulfur dioxide (SO₂), and ozone (O₃). Examples of detectors that may be part of sensor device 130 includes Non-Dispersive Infrared (NDIR) detectors used for measuring carbon dioxide (CO₂) and methane (CH₄). Electrochemical detectors that measures gases like carbon monoxide (CO), nitrogen oxides (NOₓ), and sulfur dioxide (SO₂). Flame Ionization Detectors (FID) that measures hydrocarbons, and more. In addition, sensor device 130 may be used for measuring or detecting one or more conditions such as location, temperature, light level, motion, humidity, acceleration, gas level, airflow, vibration, or other environmental conditions. Sensor device 130 may also have the ability to directly transmit and receive information in real time via a network, such as network 112. Such information may be stored in a database of a network-based non-transitory storage device, such as memory device 104A or memory device 104B.

As illustrated in FIG. 1, sensor device 130 may convey data 138 to emissions control system 100 through network 112. In some cases, data 138 may encompass emissions data and location data. The emissions data may comprise current emission levels, environmental conditions, and additional elements such as the type of pollutants being emitted, the rate of emission, and the overall impact on the surrounding environment. The emissions data transmitted to emissions control system 100, for example, data 138, may be in a raw format that does not account for properties of the item relative to properties of other items being transported in the shipment vehicles (e.g., raw emission data 140). The location information may be provided in real-time or at predetermined intervals about a shipment of an item. This may include, for example, the identification of the shipment vehicle, a shipment schedule, time-stamped GPS data, shipment scan data, carrier information, transportation method, shipping speed, alert condition information, and information regarding any modifications to the shipment. This comprehensive location data may provide a detailed overview of the shipment's journey, allowing for more precise tracking and management of emissions.

Consistent with the present disclosure, prediction engine 150 may be used to generate predictions for emissions of a particular shipment consistent with disclosed embodiments. Prediction engine 150 may use the historical data, the location information, the normalized emissions data, and other parameters to generate predictions. In some embodiments, prediction engine 150 may use a predictive modeling statistical technique to predict future behavior. Predictive modeling may use data mining to analyze historical data reflected in shipments records and normalized emissions data to generate a predictive model to predict future information, such as emissions. Predictive modeling may collect data, form a statistical model, make predictions, and revise the model based on additional data. For example, predictive models may analyze past emissions to assess future emissions based on historical data. In some cases, prediction engine 150 may use an unsupervised or a supervised predictive model. An unsupervised model does not use labeled input and output data, while a supervised model uses labeled input and output data. For example, an unsupervised predictive model may use a technique such as time series analysis or decision trees. A decision tree algorithm may take data and graph it out in branches to display the outcomes of various decisions. Decision trees may classify response variables and predict future response variables based on previous decisions. Decision trees may also be used in a random forest algorithm. Time series analysis may predict events over a sequence of time by analyzing past trends. The machine learning model may also include an extreme gradient boosted trees classifier, a random forest model, a support vector machine, a naive Bayes classifier, a classifier, a k-nearest neighbors algorithm, a linear regression model, a deep learning model, or any other type of suitable model for processing input data, such as historical data to generate a corresponding output, such as a predicted emission. Additionally, prediction engine 150 may use a supervised model such as neural networks. For example, a neural network may use machine learning techniques to review large, labeled datasets and search for correlations between variables in the data.

In some embodiments, prediction engine 150 may calculate predicted emissions of a segment of a delivery route during shipment. This may enable determining whether a predicted level of emission of an ongoing shipment of an item deviates from the target emission level. To do so, prediction engine 150 may create a predictive model using historical data. According to one implementation, prediction engine 150 may clean the historical data by removing outliers. Thereafter, prediction engine 150 may identify a predictive modeling approach to use, as described previously. In some cases, prediction engine 150 may preprocess the data into a form for the chosen modeling approach. In addition, the historical data may be used as training data. As an example, the training dataset may include samples (e.g., derived from the base dataset), where each sample may include an input vector and a target vector. The input vector may represent data related to a particular shipment corresponding to the sample. This input vector may include various data items, such as information generated from the specific shipment, related historical data, and other relevant data points. The target vector, on the other hand, may represent the actual implementation result of the particular shipment. For example, the target vector may include a value for predicted emissions calculated using historical data for the same route and transportation mode.

The samples in the training dataset may be used to train the predictive model. For training a particular machine learning model, the samples may be used, for example, iteratively. In some examples, the parameters of the predictive model (e.g., whether particular connections exist between elements of the machine learning model (the elements including, for example, trees, nodes, layers, etc.), weights of connections between the elements, or any other parameters or configurations of the machine learning model) may be adjusted based on each sample used for training the model. For example, the input vector of a sample may be input to the model, and may cause the model to produce an output. The produced output may be compared with the target vector of the sample, to adjust the parameters of the model, so that a produced output of the model based on the input vector of the sample may approach the target vector of the sample. Any suitable techniques may be used in the training, such as back-propagation, gradient descent, an iterative method, supervised learning algorithms, semi-supervised learning algorithms, unsupervised learning algorithms, reinforcement learning algorithms, etc. In some examples, the training of the model may utilize an early stopping technique and/or other suitable regularization techniques to avoid overfitting of the model to the training dataset. For example, an early stopping technique may determine the number of iterations of training that may be performed before the model may be considered to begin to overfit to the training dataset.

The historical data may comprise a certain time period of information, and may comprise any combination of the historical data as previously described. Pre-processing the data may comprise transforming the data into a format that is more easily and effectively processed in the modeling process. Data pre-processing may comprise ensuring the data exists in a matching data type. For example, all numerical values may be presented in the same format. If there are different sources that use different descriptors, the descriptors may be made uniform. For example, transportation modes may refer to “air” or “plane.” Accordingly, the data may be pre-processed to ensure these values are consistent. Data pre-processing may also comprise looking for missing data fields and performing data cleaning to add, correct, repair or remove incorrect or irrelevant data.

In some embodiments, prediction engine 150 may specify a subset of the historical data to use to train the model. In some embodiments, the model may have certain parameters that are predefined. In some embodiments, prediction engine 150 may train the model. In some embodiments, the model may be trained using subsets of the historical data and then tested by executing the model against the entire dataset. For example, the model may be trained using specific inputs such as origin, destination, and intermediate points along a route, the mode of transportation used between each point along a route, the weight and dimensions of a package, miles traveled, and fuel type. A single route may include multiple segments or legs to complete the route, and each leg may use the same or different modes of transportation. Values may be calculated for each of the legs within a route. Values may also be calculated for a total route from the origin to the destination. These data values may then be used to train the machine learning model, as previously described.

Consistent with the present disclosure, the prediction engine may check the model's performance to determine if it is accurate and adequate to make predictions. Prediction engine 150 may use the predictive model to generate predicted emissions. In some embodiments, the output of the predictive model may be a direct numeric prediction of the outcome. Testing of the machine learning model may include, for example, an evaluation of the performance of the machine learning model (e.g., based on a testing method, a validation method, a cross-validation method, an out-of-sample testing method, or any other suitable method). In other embodiments, predictions may be generated using a machine learning model that is trained using rules based on the historical data. In some embodiments, the historical data may be fed into the prediction engine 150 from an external source, such as a server, database, sensor or Internet of Things device. In some embodiments, the machine learning algorithm may be trained supervised, semi-supervised, or unsupervised. In some embodiments, predictions may be generated based on rules. In some embodiments, rules may be predefined and used to generate predictions for emissions of a shipment. Prediction engine 150 may output predicted emissions using the trained predictive model based on the input values. In some embodiments, the system may determine input values for a particular shipment to receive predicted emissions. In some embodiments, the predicted emissions may be based on real values of data and used to estimate emission score. The emission score may represent the carbon footprint of a particular shipment, such as the total amount of greenhouse gases generated by the particular shipment. In some embodiments, the emission score may be calculated by considering multiple factors, each assigned a specific weight based on its impact on emissions. For instance, factors such as shipment distance, type of service, package properties may be weighted differently according to their contribution to overall emissions. These weighted factors may then combined to produce the final emission score, providing a more accurate and comprehensive measure of the shipment's environmental impact. Examples of emissions score determined by prediction engine 150 are illustrated in GUI 300 depicted in FIG. 3B and FIG. 3C.

In another embodiment of the disclosure, a predictive system equipped with a prediction engine 150 is provided for generating emission reports. The emission reports can be utilized to adhere to regulatory standards and requirements. Alternatively, the emission reports can assist individual users in making sustainability decisions for their specific shipments. For instance, a user may input values for one or more completed shipments to generate emission reports indicating the carbon impact. This carbon impact refers to the carbon footprint of the selected shipments, which includes the total amount of greenhouse gases produced by these shipments. In some embodiments, the emission reports can be downloaded in PDF or Excel formats and may include, for example, four different charts: Emissions by shipping service, Emissions by transport mode, Ton-miles by shipping service, and Emissions by scope. Each company's shipping emissions vary, even within the same industry. Using the emission reports, companies can track its emissions monthly or quarterly, and can identify ways to lower them. In some embodiments, the emission reports can help companies to reduce emissions over time and can be used to demonstrate the companies' commitment to environmental protection to their customers.

Consistent with the present disclosure, the disclosed predictive system may calculate and include in the emission reports well-to-wheel CO2e emissions for each individual package, which includes both transport and non-transport emissions. The term “Well-to-wheel” (WTW) refers to life cycle emissions associated with the extraction, production, transport, distribution, and use of fuel in an asset, such as an aircraft, truck, or train. The transport emissions, which include aircraft, truck, rail, and ocean, may be calculated for each transport segment between the origin and destination. Non-transport emissions are associated with energy use and mobile equipment at facilities and may be allocated to packages based on package weight. In other embodiments, the disclosed predictive system may calculate and include in the emission reports Well-to-tank (WTT) emissions, which are a subset of WTW and refer to emissions associated with the extraction, production, transport, and distribution of fuel into the tank of the asset; and/or include in the emission reports Tank-to-wheel (TTW) emissions, which are another subset of WTW and refer to emissions associated with the fuel energy use from the asset's tank to combustion.

The prediction engine 150 may use a model that identifies core information of each piece of historical data. This core information may include the type of transportation, distance traveled, previous emissions data, and any other relevant information. Machine learning models may receive inputs related to the shipments and make predictions based on the input. The machine learning model may be trained on a periodic or scheduled basis. In some embodiments, prediction engine 150 may use a predictive model to perform pattern recognition and classification to determine emissions for the selected shipments. For example, if a company shipped a 100 kg package from New York to London via air transport, the system would calculate the emissions based on the distance traveled, the type of air transport, and the weight of the shipment. The calculation may be based on historical data on emissions from similar shipments. The system would then generate emission reports detailing the carbon impact of this shipment, helping the company to understand and potentially reduce its carbon footprint.

FIG. 2 is a schematic diagram of an exemplary server of a distributed system and a user device, consistent with some embodiments of the present disclosure. Server 210 illustrated in FIG. 2 may represent user management server 102A and/or shipment management server 102B. Server 210 of a distributed computing system comprises a bus 245 or other communication mechanisms for communication information, one or more processors 270 coupled with bus 245 for processing information, and one or more main processors 250 coupled with bus 245 for processing information. Processors 270 may include one or more microprocessors. In the example illustrated in FIG. 2 one or more processors 270 may include a first processor 272 and a second processor 274, both of them are connected. In some embodiments, main processors 250 may comprise a central processing unit (CPU).

In some embodiments, server 210 may transmit data to or communicate with another server 220 through network 211 (e.g., network 112). Network 211 may be a local network, an internet service provider, Internet, or any combination thereof. Communication interface 224 of server 210 is connected to network 211, which may enable communication with server 220. Server 210 may be coupled via bus 245 to peripheral devices 290, which may comprise displays and input devices (e.g., keyboard, mouse, soft keypad, etc.).

Server 210 may comprise storage devices 260, which may include memory 280 and physical storage 270. Memory 280 (e.g., memory device 140B) may include random access memory (RAM) 282 and read-only memory (ROM) 284. Storage devices 260 may be communicatively coupled with processors 270 and main processors 250 via bus 245. Storage devices 260 may include a main memory, which can be used for storing temporary variables or other intermediate information during execution of instructions to be executed by processors 270 and main processors 250. Such instructions, after being stored in non-transitory storage media accessible to processors 270 and main processors 250, render server 210 into a special-purpose machine that is customized to perform operations specified in the instructions. The term “non-transitory media” as used herein refers to any non-transitory media storing data or instructions that cause a machine to operate in a specific fashion. Such non-transitory media can comprise non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, and an EPROM, a FLASH-EPROM, NVRAM, flash memory, register, cache, any other memory chip or cartridge, and networked versions of the same.

Device 200 illustrated in FIG. 2 may represent user device 120 and/or sensor device 130. Device 200 may include a bus 205 (or other communication mechanism) interconnecting subsystems and components for transferring information within device 200. For example, bus 205 may interconnect a processing device 210, a memory device 215, sensor(s) 220, an input interface 225, an output interface 230, a network interface 235, and a storage device 240.

Processing device 210 may include any type of processor described previously; memory device 215 may include any type of memory as described previously; storage device 240 may include any type of storage device as described previously; and sensor 220 may include an image sensor such as a camera that may capture one or more images of a user's face or hands when device 200 represents user device 120 or any combination of detectors for monitoring a wide array of pollutants as described throughout the application when device 200 represents sensor device 130.

Input interface 225 may be used by device 200 to receive input from a variety of input devices, for example, a keyboard, a mouse, a touch pad, a touch screen, one or more buttons, a joystick, a microphone, an image sensor, and any other device configured to detect physical or virtual input. The received input may be in the form of at least one of: text, sounds, speech, hand gestures, body gestures, tactile information, and any other type of physically or virtually input generated by the user. Consistent with one embodiment, input interface 225 may be an integrated circuit that may act as a bridge between processing device 210 and any of the input devices listed above.

Output interface 230 may be used by device 200 to transmit output to a variety of output devices, such as a display screen, speakers, printers, haptic feedback devices, LEDs, and any other device configured to convey physical or virtual output. The generated output may be in the form of at least one of: visual displays, sounds, vibrations, printed documents, illuminated signals, and any other type of physical or virtual output perceivable by the user. Consistent with one embodiment, output interface 230 may be an integrated circuit that acts as a bridge between processing device 210 and any of the output devices listed above.

Network interface 235 may be used for providing connectivity between the different components of emissions control system 100. Network interface 235 may provide two-way data communications to a network, such as communications network 211. In one embodiment, network interface 235 may include an Integrated Services Digital Network (ISDN) card, cellular modem, satellite modem, or a modem to provide a data communication connection over the Internet. As another example, network interface 235 may include a Wireless Local Area Network (WLAN) card. In another embodiment, network interface 235 may include an Ethernet port connected to radio frequency receivers and transmitters and/or optical (e.g., infrared) receivers and transmitters. The specific design and implementation of network interface 235 may depend on the communications network or networks over which device 200 is intended to operate. For example, in some embodiments, device 200 may include network interface 235 designed to operate over a GSM network, a GPRS network, an EDGE network, a Wi-Fi or WiMAX network, and a Bluetooth network. In any such implementation, network interface 235 may be configured to send and receive electrical, electromagnetic, or optical signals that carry digital data streams or digital signals representing various types of information.

FIGS. 3A-3C illustrate various embodiments of a Graphical User Interface (GUI) 300, utilized by different user devices consistent with embodiments of the present disclosure. FIG. 3A presents a first example screenshot of GUI 300 for inputting shipping parameters of a specific shipment of an item from point F to point C. FIG. 3B depicts a second example screenshot of GUI 300 presenting two route options that the system generated for the specific shipment. FIG. 3C represents a third example screenshot of GUI 300, displaying a notification generated in response to a detection of a predicted emission deviation during the specific shipment.

In the first example screenshot of GUI 300, as depicted in FIG. 3A, user 122A (e.g., the shipper) may enter using user device 120A values for the following shipment parameters associated the shipment of the item: the shipment reference ID number (as shown in GUI element 302), the shipping service type (as shown in GUI element 304), the origin point (as shown in GUI element 306), the destination point (as shown in GUI element 308), the weight of the item (as shown in GUI element 310), the height of the item (as shown in GUI element 312), the length of the item (as shown in GUI element 314), and the width of the item (as shown in GUI element 316). Other details on the shipment of the item that may be inputted via GUI 300 include description of items, insurance details, special handling instructions, packaging type, and more. GUI 300 also features GUI element 318, which, upon selection, prompts the system to calculate one or more delivery route options based on the received shipment parameters.

In the second example screenshot of GUI 300, as depicted in FIG. 3B, the system may present two delivery route options to user 122A following the selection of GUI element 318. Each delivery route may be associated with an information display area 320 and a map display area 322. Information display area 320 may include details on the delivery route such as the type of delivery service, the route name, the estimated time of delivery, the expected emissions score, and the delivery costs. Additional details that may be shown in information display area 320 include the type of delivery vehicles used, third-party carriers, and any other information associated with the shipment of the item. In some embodiments, the expected emissions score may represent the target emission level of the shipment. Map display area 322 may include details about the stops on the way, the types of delivery vehicles used in each segment, and any other information associated with the delivery route of the item. The second example screenshot of GUI 300 also includes GUI element 324, which enables the selection of the preferred delivery route.

In the third example screenshot of GUI 300, as depicted in FIG. 3C, the system may notify any one of users 122A-E about detection of a predicted emission deviation. In some cases, the deviation may occur due to route changes caused by weather conditions, traffic congestion, or logistical decision. In other cases, deviation may occur due to unexpected changes in the delivery vehicle caused by malfunction, or delays at checkpoints, borders, or warehouses. As shown, GUI 300 may display the current location of the item on map 330 or a written description of the location of the item (e.g., at point G). GUI 300 may also display details on the emissions of the shipment, such as: the original emissions score, the updated emissions score (based on the predicted emissions levels), and a shipment delay if the user (e.g., the recipient) wishes to meet the target emissions level. Additionally, GUI 300 may display GUI element 332, which, upon selection, shows the real emission levels per completed shipping segment, and GUI element 334, which, upon selection, shows alternative routes. In some disclosed embodiments, emissions control system 100 may transmit a message to users 122, enabling them to view the updated information reflective of the emissions released during the completed segments of the shipment route. This message may be part of GUI 300 or a text message with a link to GUI 300.

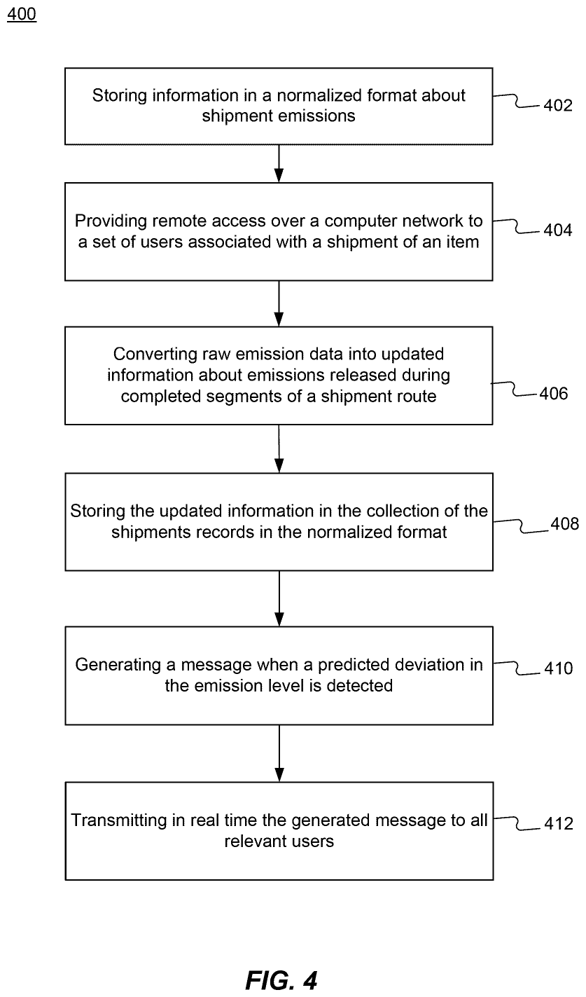

FIG. 4 illustrates a flowchart of an exemplary process 400 for preventing emission deviations of shipments, consistent with embodiments of the present disclosure. In some disclosed embodiments, process 400 may be performed by at least one processor (e.g., a processing device associated with one or more servers 102 of emission control system 100, a processing device associated with user device 120, or a processing device associated with sensor device 130) to perform operations or functions described herein. In some embodiments, some aspects of process 400 may be implemented as software (e.g., program codes or instructions) that are stored in a memory (e.g., memory device 104 shown in FIG. 1) or a non-transitory computer-readable medium. In some embodiments, some aspects of process 400 may be implemented as hardware (e.g., a specific-purpose circuit). According to other embodiments, process 400 may be implemented as a combination of software and hardware.

Step 402 of process 400 includes storing normalized data about shipment emissions. Some embodiments of the disclosure involve “storing information in a normalized format about shipment emissions in a plurality of network-based non-transitory storage devices having a collection of shipments records stored thereon.” The term “storing information” refers to the process of saving or preserving data, which may include recording, archiving, or maintaining data. For example, storing information may involve writing data to a hard drive, flash drive, or other storage medium. The term “a normalized format” refers to a standardized or uniform data structure or layout. This could mean arranging data in a way that improves data integrity. In some cases, the normalized format of the shipment emissions data may account for the emission contribution of other items being transported via shipment vehicles. For example, normalized information may include the total carbon dioxide equivalents emitted during a truck segment of a shipment route, calculated from raw sensor readings and normalized to account for the weight and volume of the shipment relative to properties of other items being transported in the shipment vehicles. In other cases, the normalized format of the shipment emissions data may account for the emission contribution of the refrigeration units used in the transportation of perishable goods or for the emission contribution of the energy used for loading and unloading the items from the shipment vehicles. The term “shipment emissions” refers to the release of pollutants or greenhouse gases produced during the transportation of items. This may include carbon dioxide, methane, or other gases produced by vehicles used in shipping. For example, shipment emissions may be measured in terms of carbon dioxide equivalents per mile traveled by a delivery truck. The term “a plurality of network-based non-transitory storage devices” refers to multiple memory devices that are connected to a network and designed to retain data for an extended period. These devices may include hard drives, solid-state drives, or other types of persistent storage. For example, a network of non-transitory storage devices may include a distributed system spread across multiple servers in various locations. Although the disclosure, the disclosed implementation of the system includes a plurality of network-based non-transitory storage devices, an alternative implementation of the system may include a single storage device for storing information in a normalized format about shipment emissions. The term “a collection of shipments records” refers to a group or set of data entries related to the transportation of items. In some cases the shipment records may include information about the origin, destination, route, carrier, and other details of each shipment and/or historical data about previous shipments. For example, a collection of shipment records could be stored in a database table with columns for shipment ID, carrier ID, origin, destination, route, shipment vehicles used per route segment, emission data per route segment.

Step 404 of process 400 includes providing remote access to shipment data for users associated with a shipment of an item. Some embodiments of the disclosure involve “providing remote access over a computer network to a set of users associated with a shipment of an item such that any one of the set of users can receive through a graphical user interface a real time update about of a deviation from a target emission level of the shipment of the item wherein a shipment route of the item has multiple segments with differing shipment vehicles that generate emission data in a raw format that does not account for properties of the item relative to properties of other items being transported in the shipment vehicles”. The term “providing remote access” refers to enabling users to connect to a system from different locations through a network. For example, providing users 122 remote access to emissions control system 100 may involve setting up a virtual private network (VPN) that allows users to securely connect to the service. The term “set of users associated with a shipment of an item” refers to at least one individual or entity that have a relationship or interest in the transportation of a particular item. This may include at least one of: a shipper, a recipient, a carrier, a logistics provider, or other parties involved in the shipment (e.g., users 122). The term “a graphical user interface” refers to a type of user interface that allows users to interact with electronic devices through graphical icons and visual indicators. The graphical user interface may include windows, icons, menus, and other visual elements that users can manipulate with a mouse, touchscreen, or other input device, for example, GUI 300 illustrated in FIG. 3. The term “a deviation” refers to a difference or variation from a standard, norm, or expected value. In the context of the present disclosure, a deviation from a target emission level represents an increase or decrease in actual emissions compared to the planned or desired level. The term “a target emission level of the shipment of the item” refers to a predetermined or desired amount of pollutants or greenhouse gases that should be produced during the shipment of a particular item. This target emission level may be set based on regulatory requirements, corporate sustainability goals, or other factors. For example, a target emission level may be expressed as a maximum amount of carbon dioxide equivalents that should be emitted per mile traveled by a delivery truck. In some cases, the target emission level for the shipment of the item may be determined based on received input from one of the users associated with shipment of the item. For example, any one of users 122 might set a lower target emission level for a shipment if he or she has a strong preference for environmentally friendly practices. In other cases, the target emission level for the shipment of the item may be determined based on emission policy associated with the item. For example, if an item being shipped is a product of a company with a strict carbon-neutral policy, the target emission level for its shipment might be set to zero. In additional cases, the target emission level for the shipment of the item may be determined based on emission policy associated with one of the set of users. For example, if a shipping company or the customer has a policy to reduce its overall carbon footprint, it might set a lower target emission level for all its shipments, regardless of the delays to items being shipped.

Consistent with the present disclosure, the term “shipment route” refers to the path that a shipment takes from its origin to its destination. This route may include multiple segments, each may involve different modes of transportation or different vehicles. The term “multiple segments” refers to several distinct parts or sections of a whole. In the context of a shipment route, multiple segments may represent different legs or stages of the journey, each may involve different vehicles or modes of transportation. For example, as illustrated in FIG. 1, a shipment route may include a truck segment from the manufacturer to the airport, an air segment from the origin city to the destination city, and another truck segment from the airport to the retailer. The term “shipment vehicles” refers to modes of transportation used to carry items from one place to another. These vehicles may include a cargo ship, a freight train, a cargo plane, or a delivery drone, or other means of conveyance, for example, shipment vehicles 132. The term “emission data” refers to information or measurements related to the release of pollutants or greenhouse gases. This data may be generated by sensors or monitoring systems on the shipment vehicles, and may be recorded in a raw format that does not account for the emission contribution of other items being transported via shipment vehicles. The term “properties of the item” refers to characteristics or attributes of the item being shipped. These properties may include the item's size, weight, shape, material composition, or other factors that may affect the emissions produced during its transportation. For example, properties of the item may include the weight and volume of a package, which could influence the fuel efficiency of the vehicle transporting it.

Step 406 of process 400 includes converting raw emission data into updated information about emissions released during completed segments of a shipment route. Some embodiments of the disclosure involve “converting by a shipment management server the raw emission data received from the shipment vehicles into updated information reflective of emissions released during completed segments of the shipment route in a normalized format.” The term “converting” refers to changing or transforming something from one form or state to another. In the context of the present disclosure, converting may involve transforming the raw emission data into updated information (i.e., normalized emission data) by taking into account the emission contribution of other items being transported via shipment vehicles. When the segments of the shipment route are associated with differing shipment vehicles, the conversation may involve converting the raw emission data from each shipment vehicle separately. For example, when the shipment vehicles includes a first and a second shipment vehicles, step 406 may include converting the raw emission data received from the first shipment vehicle into updated emission information based on shipment information associated with the first shipment vehicle and converting the raw emission data received from the second shipment vehicle into updated emission information e based on shipment information associated with the second shipment vehicle. The term “updated information” refers to new or revised data. In the context of the present disclosure, the updated information may include the emission data that was converted to a normalized format.

Consistent with the present disclosure, converting the raw emission data received from the shipment vehicles into updated emission information in the normalized format may include obtaining shipment information, determining an emission contribution of the item relative to other items being transported via shipment vehicles based on the shipment information; and determining the updated information from the raw emission data based on the relative emission contribution of the item. In some cases, the shipment information may be reflective of available load capacity of the shipment vehicles. In other cases, the shipment information may be reflective of properties of all items being transported via the differing shipment vehicles. The properties of items being transported via the differing shipment vehicles includes weight and size. For example, when converting raw emission data received from a shipment vehicle that is transporting a load of furniture from a manufacturer to a retail store. The system may account for the weight and size of each piece of furniture, as well as the available load capacity of the shipment vehicle. For instance, a large, heavy piece of furniture may be associated with a higher emission contribution than a smaller, lighter item.

Step 408 of process 400 includes storing the updated information about emissions in the collection of shipment records, in a normalized format. Some embodiments of the disclosure involve “storing the updated information in the collection of the shipments records in the normalized format.” In some cases, the storing of the updated information (i.e., the normalized emission data) may be in shipments records stored in the plurality of network-based non-transitory storage devices. In other cases, the storing of the updated information (i.e., the normalized emission data) may be in shipments records stored in a single storage devices. In accordance with the present disclosure, the disclosed system may predict the level of emission of the shipment of the item based on the stored updated information associated with completed segments of the shipment route and an estimated emission information associated with future segments of the shipment. For instance, when an item is set to be transported from London to San Francisco, the system may utilize the saved normalized emission data linked with a flight from London to New York. This data may be used to predict that a shipment of the item from New York to San Francisco will generate a quantity of carbon emissions below the target emission level. This prediction may be based on factors such as the type of vehicle expected to be used, the fuel efficiency of that vehicle, and the distance of the route. In some cases, estimating the emission information associated with future segments of the shipment may be based on historical data indicative of past emissions. For example, if the system has data showing that a similar shipment made last year produced a certain amount of emissions, it can use that data to estimate the emissions for the upcoming shipment. In other cases, estimating the emission information associated with future segments of the shipment may be based on environmental conditions. The term “environmental conditions” refer to the physical and geographical factors or characteristics of a particular area through which the shipment is or will be transported. This may include elements such as terrain (e.g., mountainous, flat, hilly), weather conditions (e.g., rain, snow, heat), road conditions (e.g., paved, gravel, dirt), or any other natural or man-made conditions that could potentially affect the fuel consumption and thus the emission levels of the transporting vehicle. For example, if the shipment route includes a mountainous region where vehicles typically consume more fuel, the system can factor this into its emissions estimate.

Step 410 of process 400 includes generating a message when a predicted deviation in the emission level is detected. Some embodiments of the disclosure involve “automatically generating a message when a predicted level of emission deviates from the target emission level.” The term “automatically generating a message” refers to the process of creating a notification or alert without human intervention. This may include, but is not limited to, sending an email, a text message, or a push notification. For example, emissions control system 100 may be programmed to send an email alert when a certain condition is met. The term “deviates from the target emission level” refers to a difference or variation from a predetermined or desired level of emission. This could mean that the actual or predicted emissions are higher or lower than the target level. For example, a message may be generated when predicted emissions exceed the target emission level by a certain threshold, for instance, 10%, although other thresholds may also be used. In some cases, when the system determines the shipment route based on the target emission level, the generated message may indicate that the system had automatically initiated a change to a predetermined shipment route when the predicted level of emission of the shipment of the item deviates from the target emission level. For example, if the predicted emissions for a shipment route are 15% higher than the target level, the system may automatically reroute the shipment to a more eco-friendly route and generate a message to notify the relevant parties of this change. In other cases, when the system determines which shipment vehicles to use for shipping the item based on the target emission level, the generated message may indicate that the system is automatically initiating a change to the shipment vehicles when the predicted level of emission of the shipment of the item deviates from the target emission level. For example, if in a first segment of the delivery route the actual emissions were 20% above the predicted level of emission, the system may automatically switch the shipment vehicle in a second subsequent segment to a more environmentally friendly vehicle, like an electric van, and generate a message to inform the relevant parties of this change. In some embodiments, one or more authorized users may have the option to override an automatic switch of the shipment vehicles or an automatic switch of the driving route.

Step 412 of process 400 includes transmitting in real time the generated message to all relevant users. Some embodiments of the disclosure involve “transmitting the message to all of the set of users over the computer network in real time such that any one of the set of users can view the updated information.” The term “transmitting” refers to the process of sending or conveying information from one place to another. This could be done through various means, including but not limited to, electronic communication channels such as email, text message, or a web-based platform. For example, transmitting could involve sending an email alert to all users associated with a shipment. The term “view the updated information” refers to the ability to access and read the normalized emission data. This could be done through various means, such as a web-based platform, a mobile app, or an email. For example, users could log into a web-based platform to view the normalized emissions data for a shipment. In some cases, the message includes a suggestion or a link to website that presents an alternative shipping route via GUI that would correct the deviation from the target emission level of the shipment of the item. For example, the message might suggest rerouting a shipment through a less congested route to reduce emissions. Specifically, GUI element 334 illustrated in FIG. 3C may trigger presentation of one or more alternative routes. In other cases, the message may include a report or a link to a report containing the updated information about the shipment of the item in the normalized format. For example, the report might include details about the shipment's current location, estimated arrival time, and normalized emission. Specifically, GUI element 332 illustrated in FIG. 3C may trigger presentation of a report showing the real emission levels per completed shipping segments. Process 400 may include an optional step, prior to transmitting the generated message, of authenticating the set of users to confirm that each user has permission to receive the updated information associated with the shipment of the item, and transmitting the message to all authenticated users. For example, authenticating users could involve sending them verification link to each user's registered email address to confirm their identity and their association to the delivery of the item before granting access to the shipment information.

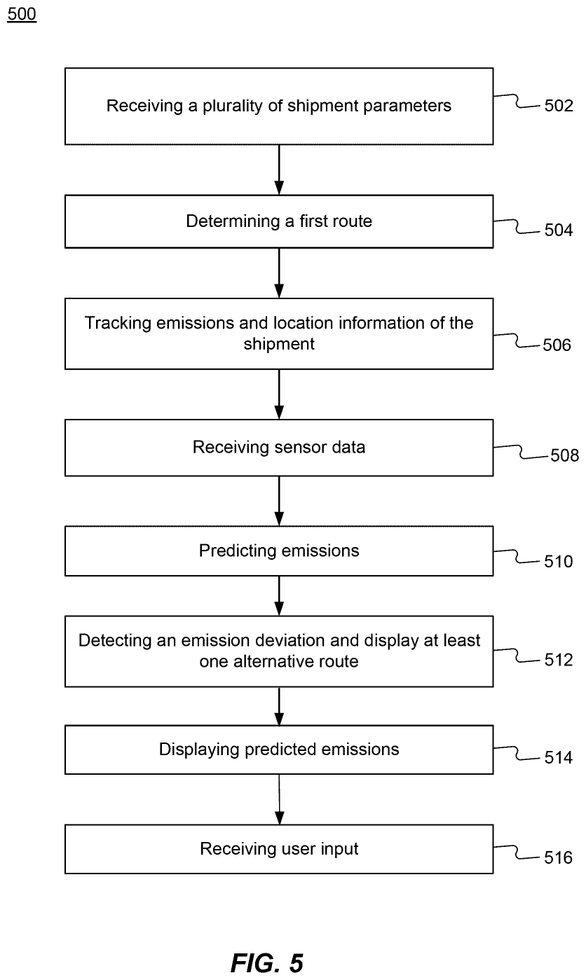

FIG. 5 illustrates a flowchart of an exemplary process 500 for diverting shipment to an alternative route when a predicted emission deviation of a shipment is detected. In some disclosed embodiments, process 500 may be performed by at least one processor (e.g., a processing device associated with one or more servers 102 of emission control system 100, a processing device associated with user device 120, or a processing device associated with sensor device 130) to perform operations or functions described herein. In some embodiments, some aspects of process 500 may be implemented as software (e.g., program codes or instructions) that are stored in a memory (e.g., memory device 104 shown in FIG. 1) or a non-transitory computer-readable medium. In some embodiments, some aspects of process 500 may be implemented as hardware (e.g., a specific-purpose circuit). In some embodiments, process 500 may be implemented as a combination of software and hardware. It is appreciated that the illustrated method 500 may be altered to modify the order of steps and to include additional steps.

In step 502, the disclosed system may receive a plurality of shipment parameters associated with a particular shipment of an item, wherein the plurality of shipment parameters comprises historical data. Examples of the plurality of shipment parameters are disclosed with reference to FIG. 3A. A particular shipment may comprise one or more packages, pallets, or any type of shipment as described herein.

In step 504, the disclosed system may determine a first route for the particular shipment comprising an origin point and a destination point. Determining a route for a shipment typically begins by analyzing various factors such as the distance between the origin and destination points, available transportation modes, and expected transit times. It may use real-time data or historic data to assess traffic conditions, weather forecasts, and any potential disruptions like road closures or delays. The disclosed system may consider cost-efficiency and environmental impact, when determining the first route. In some embodiments, determining the first route may be based on user input on a user interface. The first route may be determined based on the target emission level. In some embodiments, additional information associated with the first route may be determined. For example, the additional information may comprise types of transportation associated with different segments of the first route.

In step 506, the disclosed system may track, using one or more sensors, the emissions for the particular shipment and the location information for the particular shipment. In some embodiments, the one or more sensors may include a shipment sensing device that may be activated and associated with a particular shipment. For example, a courier or employee of the shipper transporting the shipment may turn on the shipment sensing device and place it in or attach it to packaging associated with a particular shipment. In the alternative, the shipment sensing device may be placed within or near a particular shipment. The courier or employee may also associate the shipment sensing device with an item tracking number. The item tracking number may be stored in a database. The shipment sensing device may include sensors that measure or detect one or more conditions such as location, temperature, light level, motion, pressure, humidity, gas level, airflow, vibrations, emissions, or other environmental conditions. The detected level of emissions may refer to the amount of carbon dioxide (CO₂), methane (CH₄), nitrous oxide (N₂O). In some embodiments, the shipment sensing device may alter data collection and transmission rates based on a shipment status or GPS location. For example, the shipment sensing device may alter data collection or transmission rates when a particular shipment is scheduled to be on an airplane flight. As another example, the shipment sensing device may alter a package status (e.g., in transit, delivered, awaiting pickup, at a sorting facility, returned to sender, and more) by analyzing GPS, accelerometer, air pressure, altitude, and temperature data. In other embodiments, the one or more sensors may include an emission sensing device (e.g., sensor device 130) associated with the shipment vehicle that may be activated when the shipment vehicle operates. Emission sensing devices may measure any emissions, such as, carbon emissions (or carbon dioxide emissions), greenhouse gas emissions (e.g., methane or nitrous oxide emissions), air pollutant emissions, or any other emissions.

In step 508, the disclosed system may receive sensor data (e.g., emission information and location information) transmitted either periodically, on a specified schedule, or on demand. In step 510, the disclosed system may use a prediction engine (prediction engine 150) to estimate the emissions for the particular shipment based on the received sensor data and historical data. In some embodiments, the disclosed system may use machine learning models to understand the sensor data. In some embodiments, the prediction engine may use a model that identifies core information of each piece of historical data. For example, in a transportation environment, the core information may include the type of transportation, distance traveled, previous emissions data, and any other relevant information. Machine learning models may receive inputs related to the particular shipment and make predictions based on the input. Training the machine learning models may rely on the use of historical data, tracking the actual emissions of shipments during the training, and predicting the future emissions of shipments using the machine learning model. The machine learning model may be trained on a periodic or scheduled basis. In some embodiments, the prediction engine may use a predictive model to perform pattern recognition and classification to determine emissions for shipments.

In step 512, the disclosed system may detect an emission deviation and display at least one alternative route for the particular shipment. The emission deviation may be detected compared to an original estimated values of emissions, as described above. The at least one alternative route for the particular shipment may be determined based on the historical data, the location information, and the emission information. The at least one alternative route may be displayed by user devices (e.g., user devices 120) in real time. The user devices may include any form of a computer-based device or entity. In some cases, the at least one alternative route may be sent to a user interface, such as user interface 300. In some embodiments, the at least one alternative route may have different shipment parameters associated with the route, including an expected delivery time of the shipment, a type of shipping vehicle for the shipment, shipment time, miles traveled for the shipment, and any other shipment parameters. Consistent with some embodiments, the at least one alternative route for the particular shipment may not be displayed if an emission deviation is not detected.

In step 514, the prediction system may cause a display, on a user interface, of the predicted emissions for the particular shipment for the first route and for the at least one alternative route. In some embodiments, the at least one alternative route may have less emissions associated with the current route. In some embodiments, the user interface (e.g., user interface 300) may present historical emissions calculated based on the historical data. The user interface may also present predicted emissions based on predicted outputs from the predication engine. The user interface may also present reports used to comply with regulatory standards and requirements. For example, the reports may be used by a user to make a sustainability decision for their particular shipment.

In step 516, the disclosed system may receive user input to select the first route or one of the at least one alternative routes for the particular shipment. User input may be determined by a user, such as user 122. In some embodiments, a user may input a selection of a route on user device 120 using user interface 300. In some embodiments, in response to user input, the particular shipment may be diverted to the alternative route. In other embodiments, prior to diverting the shipment to the alternative route, the disclosed system may authenticate the set of users to confirm that each user has permission to change the shipment route of the item.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above-described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units can be combined as one module or unit, and each of the above-described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof. And other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A non-transitory computer readable medium containing instructions that when executed by at least one processor cause the at least one processor to perform operations for preventing emission deviations of shipments, the operations comprising:
storing information in a normalized format about shipment emissions in a plurality of network-based non-transitory storage devices having a collection of shipments records stored thereon;
providing remote access over a computer network to a set of users associated with a shipment of an item, such that any one of the set of users can receive through a graphical user interface a real time update about a deviation from a target emission level of the shipment of the item, wherein a shipment route of the item has multiple segments with differing shipment vehicles that generate emission data in a raw format that does not account for properties of the item relative to properties of other items being transported in the shipment vehicles;
converting, by a shipment management server, the raw emission data received from the shipment vehicles into updated information reflective of emissions released during completed segments of the shipment route in a normalized format;
storing the updated information in the collection of the shipments records in the normalized format;
automatically generating a message when a predicted level of emission of the shipment of the item deviates from a target emission level; and
transmitting the message to all of the set of users over the computer network in real time, such that any one of the set of users can view the updated information reflective of the emissions released during the completed segments of the shipment route in a normalized format.

2. The non-transitory computer readable medium of claim 1, wherein the message includes a suggestion for an alternative shipping route that corrects the deviation from the target emission level of the shipment of the item.

3. The non-transitory computer readable medium of claim 1, wherein the message includes a report containing the updated information about the shipment of the item in the normalized format.

4. The non-transitory computer readable medium of claim 1, wherein the different shipment vehicles includes a first shipment vehicle including a road vehicle and a second shipment vehicle including one of a cargo ship, a freight train, a cargo plane, or a delivery drone.

5. The non-transitory computer readable medium of claim 4, wherein the operations further include converting the raw emission data received from the first shipment vehicle and the second shipment vehicle into updated emission information based on shipment information associated with the first shipment vehicle and the second shipment vehicle.

6. The non-transitory computer readable medium of claim 1, wherein converting the raw emission data received from the shipment vehicles into updated emission information in the normalized format includes: obtaining shipment information, determining an emission contribution of the item relative to other items being transported via shipment vehicles based on the shipment information; and determining the updated information from the raw emission data based on a relative emission contribution of the item.

7. The non-transitory computer readable medium of claim 6, wherein the shipment information is reflective of an available load capacity of the shipment vehicles.

8. The non-transitory computer readable medium of claim 6, wherein the shipment information is reflective of properties of at least some of the items being transported via the different shipment vehicles.

9. The non-transitory computer readable medium of claim 8, wherein the properties include at least one of a weight and a size of at least one of the items being transported via the different shipment vehicles.

10. The non-transitory computer readable medium of claim 1, wherein the operations further include determining the target emission level for the shipment of the item based on received input from one of the set of users associated with shipment of the item.

11. The non-transitory computer readable medium of claim 1, wherein the operations further include determining the target emission level for the shipment of the item based on an emission policy associated with the item.

12. The non-transitory computer readable medium of claim 1, wherein the operations further include determining the target emission level for the shipment of the item based on an emission policy associated with one of the set of users.

13. The non-transitory computer readable medium of claim 1, wherein the operations further include determining the shipment route based on the target emission level, and automatically initiating a change to the shipment route when the predicted level of emission of the shipment of the item deviates from the target emission level.

14. The non-transitory computer readable medium of claim 1, wherein the operations further include determining which shipment vehicles to use for shipping the item based on the target emission level, and automatically initiating a change to the shipment vehicles when the predicted level of emission of the shipment of the item deviates from the target emission level.

15. The non-transitory computer readable medium of claim 1, wherein the operations further include predicting the level of emission of the shipment of the item based on the updated information associated with completed segments of the shipment route and an estimated emission information associated with future segments of the shipment.

16. The non-transitory computer readable medium of claim 15, wherein estimating the emission information associated with future segments of the shipment is based on historical data indicative of past emissions.

17. The non-transitory computer readable medium of claim 15, wherein estimating the emission information associated with future segments of the shipment is based on environmental conditions.

18. The non-transitory computer readable medium of claim 1, wherein the set of users includes at least one of: a shipper, a recipient, a carrier, or a logistics provider.

19. The non-transitory computer readable medium of claim 1, wherein the operations further includes authenticating the set of users to confirm that each user has permission to receive the updated information associated with the shipment of the item, and transmitting the message to all authenticated users.

20. A system for preventing emission deviations of shipments, the system comprising:
at least one processor configured to:
provide remote access over a computer network to a set of users associated with a shipment of an item, such that any one of the set of users can receive through a graphical user interface a real time update about of a deviation from a target emission level of the shipment of the item, wherein a shipment route of the item has multiple segments with differing shipment vehicles that generate emission data in a raw format that does not account for properties of the item relative to properties of other items being transported in the shipment vehicles;
convert, by a shipment management server, the raw emission data received from the shipment vehicles into updated information reflective of emissions released during completed segments of the shipment route in a normalized format;
store the updated information in shipments records in the normalized format;
automatically generate a message when a predicted level of emission of the shipment of the item deviates from the target emission level; and
transmit the message to all of the set of users over the computer network in real time, such that any one of the set of users can view the updated information reflective of the emissions released during the completed segments of the shipment route in a normalized format.
